(19) United States
(12) Patent Application Publication
(10) Pub. No.: US 2023/0323713 A1
(43) Pub. Date: Oct. 12, 2023

(54) Device for holding an opening element in an ajar position, comprising a protective wall

(71) Applicant: EXSTO THERMOPLASTICS, ROMANS SUR ISERE (FR)

(72) Inventors: Olivier BOURGEOIS, VILLAGES DU LAC DE PALADRU (FR); Bertrand LEON, TULLINS (FR)

(21) Appl. No.: 18/025,035

(22) PCT Filed: Sep. 10, 2021
(86) PCT No.: PCT/FR2021/051552

§ 371 Date: Mar. 7, 2023

(30) Foreign Application Priority Data
Sep. 14, 2020 (FR) 20/09294

(51) Int. Cl. E05C 21/00; E05C 17/52

(52) U.S. Cl. CPC E05C 21/005; E05C 17/52

(57) ABSTRACT

A device for holding an opening element in an ajar position relative to a fixed part of a body of a motor vehicle, the device including a first element having at least one connection member and a second element having at least one retention member having at least one elastically deformable body configured to cooperate with a second area of the at least one connection member so as to prevent the opening element from opening; the holding device comprises at least one protective wall defining a receiving recess in which the at least one elastically deformable body is at least partially housed. The invention also relates to a vehicle provided with at least one holding device of the type mentioned above.

### TECHNICAL FIELD

The present disclosure concerns the field of devices used during the assembly of a motor vehicle and more particularly a device for holding in the ajar position a door leaf element with respect to a fixed part of a body shell of a vehicle.

### BACKGROUND

In a mounting line, door leaf elements of a motor vehicle, such as doors for example, are assembled to fixed elements, such as uprights of a body shell of the vehicle, thus forming the bodywork of said vehicle. The bodywork is then painted in a paint line.

The door leaf elements, not yet equipped with a closing device, or with latches, tend, by their weight and by forces and shocks exerted by the mounting line during the movements of the body shells, to be placed in a position of opening relative to the fixed element. However, both for optimizing the size of the mounting line and for optimum painting, the door leaf elements must be held in an ajar position with respect to the fixed element. Thus, it is necessary to set up temporary holding devices.

It is known in the art of holding devices of the aforementioned type, for example in the document EP1893832 having a device comprising a body provided with mounting means making it possible to fix said device to the bodywork of the vehicle, a retaining means comprising a tab whose first end is designed to cooperate with a first flange of a housing, and whose second end ensures a junction with the body, and an abutment intended to cooperate with a second flange of said housing. This device is provided to be positioned on a door leaf element or a fixed element and is satisfactory in that it makes it possible to effectively hold in the ajar position the door leaf element with respect to the fixed element.

However, the various retaining elements, such as the tab, may generate grains or dust by abrasion, or tearing of the plastic material constituting them, or of the paint which covers them, in particular upon contact between the sheet of the vehicle and the retaining element. These grains or dust may be projected onto the body shell of the vehicle and held thereon, in particular if it is wet, thus generating extra thicknesses, or aesthetic defects.

Furthermore, the use of a single retaining element generally involves the formation of a paint defect at the fixing zone of said retaining element. Such a defect may be visible to the end user of the vehicle.

Finally, the elements such as the tab tend to retain the paint and to project the latter during a subsequent manipulation of the device. Thus, a projection of paint droplets may create appearance defects when the door leaf element moves from an opening position to an ajar position, or vice versa.

### BRIEF SUMMARY

The disclosure proposes a solution which responds to all or part of the aforementioned problems.

This may be achieved through the implementation of a device for holding in the ajar position a door leaf element with respect to a fixed part of a body shell of a motor vehicle; comprising:
a first element intended to cooperate with a first support chosen from among the fixed part or the door leaf element, said first element comprising at least one connecting member;
a second element intended to cooperate with a second support chosen from among the fixed part or the door leaf element, said second element comprising at least one retaining member comprising at least one elastically deformable body, configured to cooperate with a second zone of the at least one connecting member so as to oppose the displacement of the door leaf element with respect to the fixed part in the opening direction of the door leaf element.

The holding device comprises at least one protective wall defining a receiving housing in which the at least one elastically deformable body is at least partially housed.

The previously described holding device makes it possible to hold a motor vehicle door in an ajar position during the manufacture of this vehicle. In particular, but not exclusively, the holding device may be used during a step of treating the body shell with paint or an anti-corrosion coating. The presence of the protective wall makes it possible advantageously to prevent paint from entering the receiving housing and being deposited on the functional parts of the device and in particular on the elastically deformable body. The absence or reduction of the quantity of dry paint on the elastically deformable part avoids the flaking of this paint into small particles which could fall on the body shell and form grains; the presence of the protective wall also advantageously makes it possible to contain the (unlikely) grains and dust which would be generated by abrasion or tearing of the plastic material constituting the device or of the paint covering the latter. Synergistically, the protective wall helps prevent this still wet paint from being ejected unintentionally by said elastically deformable body during another step of the manufacturing method.

The holding device may also have one or more of the following characteristics, taken alone or in combination.

According to one embodiment, the holding device comprises an abutment surface configured to cooperate with a first zone of the connecting member so as to oppose a displacement of the door leaf element with respect to the fixed part in the closing direction of the door leaf element.

According to one embodiment, the abutment surface is included on the second element.

According to one embodiment, the abutment surface is included on the retaining member.

According to one embodiment, the abutment surface comprises a portion of a sphere, so as to present a substantially point-like zone of cooperation between the first zone of the connecting member and the abutment surface.

According to one embodiment, the first element and the second element may each be made of a single material, for example a thermoplastic material. The first element and the second element may then be obtained by a thermoplastic molding method.

According to one embodiment, the first element is intended to be fixed on the first support, and the second element is intended to be fixed on the second support.

According to one embodiment, the receiving housing may form a receiving cavity in which the at least one elastically deformable body is at least partially housed.

According to one embodiment, the at least one elastically deformable body is completely contained within the receiving housing.

According to one embodiment, the receiving housing has a limited internal volume in which the at least one elastically deformable body is contained.

By “limited internal volume” is meant that the internal volume of the receiving housing is fixed.

According to one embodiment, the holding device comprises a plurality of protective walls defining the receiving housing.

According to one embodiment, the at least one protective wall extends around the elastically deformable body and has a lateral dimension, a longitudinal dimension and a transverse dimension strictly greater than the largest dimension of the elastically deformable body.

According to one embodiment, the at least one protective wall and the elastically deformable body have a transverse dimension counted along the introduction axis. According to this embodiment, the transverse dimension of the at least one protective wall is strictly greater than the transverse dimension of the elastically deformable body.

According to one embodiment, the at least one protective wall and the elastically deformable body have a longitudinal dimension counted along a longitudinal direction perpendicular to the introduction axis. According to this embodiment, the longitudinal dimension of the at least one protective wall is strictly greater than the longitudinal dimension of the elastically deformable body.

According to one embodiment, the at least one protective wall and the elastically deformable body have a lateral dimension counted along a lateral direction perpendicular to the introduction axis and the longitudinal direction. According to this embodiment, the lateral dimension of the at least one protective wall is strictly greater than the lateral dimension of the elastically deformable body.

According to one embodiment, each of the transverse dimension, the longitudinal dimension and the lateral dimension of the at least one protective wall is strictly greater than the corresponding dimension of the elastically deformable body.

In this way, the at least one protective wall makes it possible to spatially encompass the elastically deformable element in all directions to provide better protection against the projections, and in particular the paint projections.

According to one embodiment, the holding device is movable with respect to the first element and to the second element. In other words, the holding device is separate from the first element and from the second element and may simply be removed by the action of an operator.

According to one embodiment, the displacement of the door leaf element with respect to the fixed part is a pivotal displacement.

According to one embodiment, the elastically deformable body comprises a free distal end portion configured to cooperate with the connecting member.

According to one embodiment, the elastically deformable body comprises at least one tab.

Generally, the protective wall is configured to at least partially protect the elastically deformable body.

According to one embodiment, the second zone has a substantially planar surface on which the free distal end portion of the elastically deformable body comes to rest, in particular when the door leaf element is offset in the direction of its opening. Advantageously, the elastically deformable body has stiffness sufficient to prevent an offset of the door leaf element with respect to the fixed part greater than a threshold value, for example substantially equal to 70 mm, when the elastically deformable body is subjected to a force less than a target force, for example of between 10N and 200N. Furthermore, the elastically deformable body may have elasticity sufficient to allow the opening of the door leaf element with respect to the fixed part beyond the threshold value, when the elastically deformable body is subjected to a force greater than or equal to the target force. For this, the elastically deformable body may be configured to withstand a maximum stress of between 30 MPa and 120 MPa and in particular between 60 MPa and 90 MPa.

According to one embodiment, the first zone has a substantially planar surface coming to rest on the abutment surface, in particular when the door leaf element is moved in the direction of its closing. Advantageously, the first zone has a mechanical strength sufficient to prevent complete closing of the door leaf element on the fixed part.

According to one embodiment, the second element comprises a base body, the retaining member and the protective wall both extending from the base body.

According to this embodiment, the elastically deformable body may comprise a proximal end secured to the base body, said elastically deformable body being configured to deform at the proximal end.

According to one embodiment, the connecting member is configured to be housed at least partly in the receiving housing.

According to one embodiment, the connecting member extends at least partially into the receiving housing.

According to one embodiment, the protective wall comprises a passage opening configured to allow the introduction of the connecting member inside the receiving housing, or alternatively the removal of the connecting member outside of the receiving housing so as to define an introduction axis.

According to one embodiment, the protective wall extends at least partly around the introduction axis.

According to one embodiment, the protective wall is offset with respect to the elastically deformable body according to a plane perpendicular to the introduction axis.

According to one embodiment, the holding device comprises two protective walls opposed with respect to the introduction axis, for example the protective walls may be diametrically opposed with respect to the introduction axis. For example, said two protective walls may extend from the base body.

According to one embodiment, the protective wall forms the abutment surface.

According to one embodiment, the protective wall has a substantially cylindrical shape.

According to one embodiment, the protective wall has a front edge defining the abutment surface.

According to one embodiment, the retaining member comprises at least two elastically deformable bodies and the connecting member comprises a distal termination, for example having the shape of a ball or a point, and configured to be inserted and snapped between said at least two elastically deformable bodies and further comprises a connecting rod connecting said distal termination to the first element.

According to one embodiment, the connecting rod comprises a first end secured to the distal termination and a second end, opposed to the first end and secured to connecting arms configured to allow a range of movement of the distal termination with respect to the first support.

The arrangements previously described make it possible to guarantee that the holding device may adapt to variations in the position of the door leaf element with respect to the fixed part.

According to one embodiment, the first element comprises the connecting arms connecting the second end of the connecting rod to the first element.

According to one embodiment, the retaining member comprises at least two elastically deformable bodies forming a jaw intended to receive the connecting member.

According to this embodiment, the retaining member comprises a base connecting the jaw formed by the two elastically deformable bodies to the base body of the retaining member. It is therefore well understood that the jaw comprises the two elastically deformable bodies which are joined at the base.

According to one embodiment, the elastically deformable bodies each comprise a convex curved section configured to retain the connecting member in a housing formed between said two elastically deformable bodies.

According to one embodiment, each elastically deformable body comprises an end fin connected to the convex curved section and moving away from the introduction axis.

Thus, during the introduction of the connecting member, the slope formed by the end fins simplifies the introduction of the connecting member into the housing formed by the convex curved sections.

According to one embodiment, the housing formed by the convex curved sections has a generally cylindrical shape, making it possible to form a sliding connection perpendicular to the introduction axis.

Thus, the connecting member may slide in the jaw, which makes it possible to adapt, along this axis, to strong variations in the position of the door leaf with respect to the fixed part.

According to one embodiment, the retaining member comprises a female snap element configured to cooperate with a male snap element provided on the protective wall, so that the protective wall may occupy a separate configuration in which the female snap element and the male snap element are disjointed and a snapped configuration in which the female snap element and the male snap element cooperate with each other.

Advantageously, the holding device may be made by molding in the separate configuration, placed on the vehicle, then disposed in the snapped configuration to guarantee better protection of the retaining member by the protective wall.

According to one embodiment, the first element and the second element comprise fixing means, intended to allow the fixing of the first element with the first support and of the second element with the second support.

According to one embodiment, at least one element chosen from among the first element and the second element is configured to be fixed on an external surface of the first support or of the second support. For example, said element may be fixed to a hole accessible from the outside of the first support or of the second support. By “accessible”, is meant that an operator may directly fix the first element or the second element on the first support or the second support without requiring the dismantling of said first or second support, and without requiring the insertion of said first or second element inside the first support or the second support.

In this way, the installation of the holding device is simplified, and its use is more ergonomic.

According to one embodiment, the fixing means comprise an interlocking member intended to interlock with the first support and/or the second support.

According to one embodiment, the fixing means comprise a snap member intended to snap into a first slot included on the first support and/or the second support.

According to one embodiment, the fixing means comprise a locking member having a locking portion, the locking member being movable between an unlocked configuration in which the locking portion is able to be passed through a second slot provided in the first support or the second support; and a locked configuration in which the locking portion is able to rest on the first support or the second support.

According to one embodiment, the locking member has a shape adapted to be inserted into the second slot, and to occupy the locked configuration when it is fixed to the second slot by rotation of the locking member, and in particular by rotation of a quarter turn.

According to one embodiment, the means for fixing the second element comprise a locking member having a locking portion intended to cooperate with a rest element. The locking member may then be movable between an unlocked configuration in which the locking portion is able to be passed successively through a second slot provided in the second support, and through a third slot provided in the rest element; and a locked configuration in which the locking portion is able to rest on the rest element. Said rest element being disposed between the locking portion of the locking member and the second support when the locking member is in the locked configuration. The locking member may in particular have a shape adapted to be inserted into the second slot and the third slot. The locking member may also occupy the locked configuration when it is fixed to the rest element by rotation of a quarter turn of the locking member.

According to a first example, the locking member may comprise a gripping part, for example formed by the second element, a first rest surface and a second rest surface. The gripping part may also be formed by the connecting member and have a size allowing an operator to grasp it with a few fingers so as to be able to perform a rotation of a quarter turn. The first rest surface is positioned between the gripping part and the second rest surface. Each of the longitudinal ends of the second rest surface may be prolonged by the locking portion so that the locking portion may slide through cooperation by rotation with the rest element, to be placed in the locked configuration, in particular when the second rest surface comes to rest on a shoulder of the rest element.

According to a second example, the second slot and the locking member have an oblong shape, the locked configuration is therefore obtained by rotation of a quarter turn of said oblong part of the locking member which then comes to rest partially on the first support or the second support.

According to a third example, the locking member may comprise a blocking part comprising two peaks configured to slide respectively in two guides provided in one or the other of the first element or of the second element, when the locking member is moved between the unlocked configuration and the locked configuration by rotation.

According to one embodiment, the locking member comprises a sliding surface forming a ramp against which an edge of the second slot is able to slide to allow the locking portion to pass through said second slot between the unlocked configuration and the locked configuration.

According to one embodiment, the first element comprises two connecting members spaced apart from each other and symmetrical with respect to a median plane.

According to one embodiment, the first element comprises two retaining members spaced apart from each other and symmetrical with respect to a median plane.

For example, the two connecting and/or retaining members may be sufficiently spaced so as to allow the introduction of one of them into the receiving housing.

The arrangements previously described make it possible to use a single first element or a single second element which may be adapted both to a left door leaf element and to a right door leaf element of a motor vehicle.

The disclosure also involves implementation of a vehicle provided with at least one holding device of the type of one of those described previously.

### BRIEF DESCRIPTION OF THE DRAWINGS

Other aspects, advantages and characteristics of the disclosure will appear better on reading the following detailed description of preferred embodiments thereof, given by way of non-limiting example, and made with reference to the appended drawings on which ones:

FIG. 1 is a schematic perspective view of the holding device according to a particular embodiment of the disclosure.

FIG. 2 is a schematic perspective view of the first element of the holding device of FIG. 1 when it cooperates with the fixed part.

FIG. 3 is a schematic perspective view of the second element of the holding device of FIG. 1.

FIG. 4 is a schematic perspective view of the holding device having a locking member according to a particular embodiment of the disclosure.

FIG. 5 is a schematic perspective view of the holding device having a locking member according to a particular embodiment of the disclosure.

FIG. 6 is a schematic perspective view of the second element according to a second embodiment of the disclosure.

FIG. 7 is a schematic view of a second element according to a third embodiment of the disclosure, comprising a protective wall in the separated configuration.

FIG. 8 is a schematic view of the second element of FIG. 7, when the protective wall is in the snapped configuration.

FIG. 9 is a schematic perspective view of a second element according to a fourth embodiment of the disclosure.

FIG. 10 is a schematic perspective view of a first element according to the embodiment represented in FIG. 9.

FIG. 11 is a schematic side view of the holding device according to the embodiment represented in FIG. 9.

FIG. 12 is a schematic sectional view along the section A-A of the holding device of FIG. 11.

FIG. 13 is a schematic sectional view along the section B-B of the holding device of FIG. 11.

FIG. 14 is a schematic perspective view of the second element according to one embodiment of the disclosure.

FIG. 15 is a schematic perspective view of the first element according to one embodiment of the disclosure.

### DETAILED DESCRIPTION

In the figures and in the remainder of the description, the same references represent identical or similar elements. In addition, the different elements are not represented to scale so as to favor the clarity of the figures. Furthermore, the different embodiments and variants are not mutually exclusive and may be combined with one another.

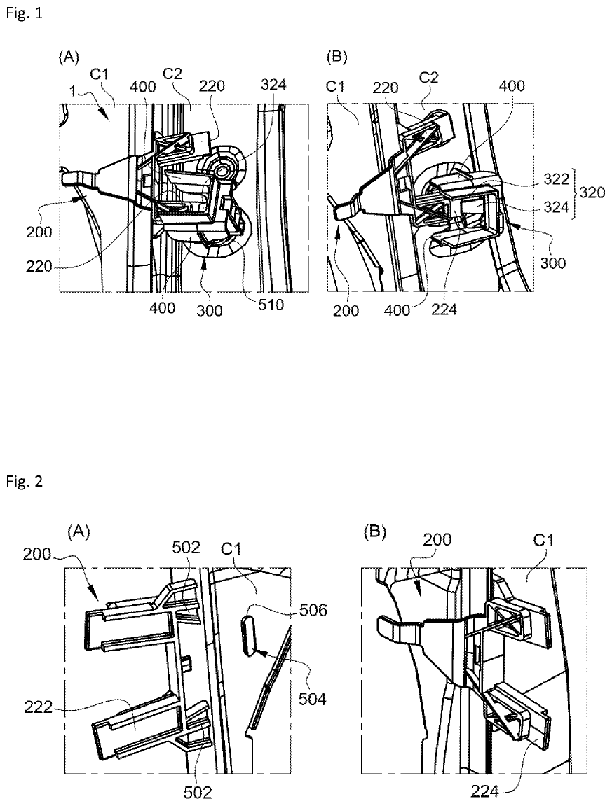

As illustrated in FIG. 1, the disclosure concerns a device 1 for holding in the ajar position a door leaf element with respect to a fixed part of a body shell of a motor vehicle. The holding device 1 is therefore separate from the door leaf element and from the fixed part.

According to the non-limiting embodiment represented in FIG. 1, the holding device 1 comprises a first element 200 intended to cooperate with a first support C1 comprising the fixed part, and a second element 300 intended to cooperate with a second support C2 comprising the door leaf element. In particular, the first element 200 is intended to be fixed on the first support C1, and the second element 300 is intended to be fixed on the second support C2. For this the first element 200 and the second element 300 comprise fixing means, intended to allow the fixing of the first element 200 with the first support C1 and of the second element 300 with the second support C2. Alternatively, the holding device 1 may be removed from the first support C1, or from the second support C2 by the action of an operator.

According to one embodiment, at least one element chosen from among the first element 200 and the second element 300 is configured to be fixed on an external surface of the first support C1 or of the second support C2. For example, said element 200, 300 may be fixed to an accessible hole disposed on the external surface of the first support C1 or of the second support C2. By “accessible”, is meant that an operator may fix the first element 200 or the second element 300 directly on the first support C1 or the second support C2, and without requiring manipulation requesting the insertion of said first or second element 200, 300 inside the first support C1 or the second support C2.

In this way, the installation of the holding device 1 is simplified, and its use is more ergonomic.

In the rest of the description, embodiments represent the first element 200 fixed on the first support C1, and the second element 300 fixed on the second support C2 through fixing means. These embodiments may simply be adapted by those skilled in the art to use the fixing means to fix either the first element 200, or the second element 300 respectively to the first support C1, or to the second support C2.

FIG. 2 presents the first element 200 according to one embodiment of the disclosure. The means for fixing the first element 200 may comprise two interlocking members 502 intended to interlock with the first support C1. The first element 200 may also comprise a snap member 504 intended to snap into a first slot 506 included on the first support C1.

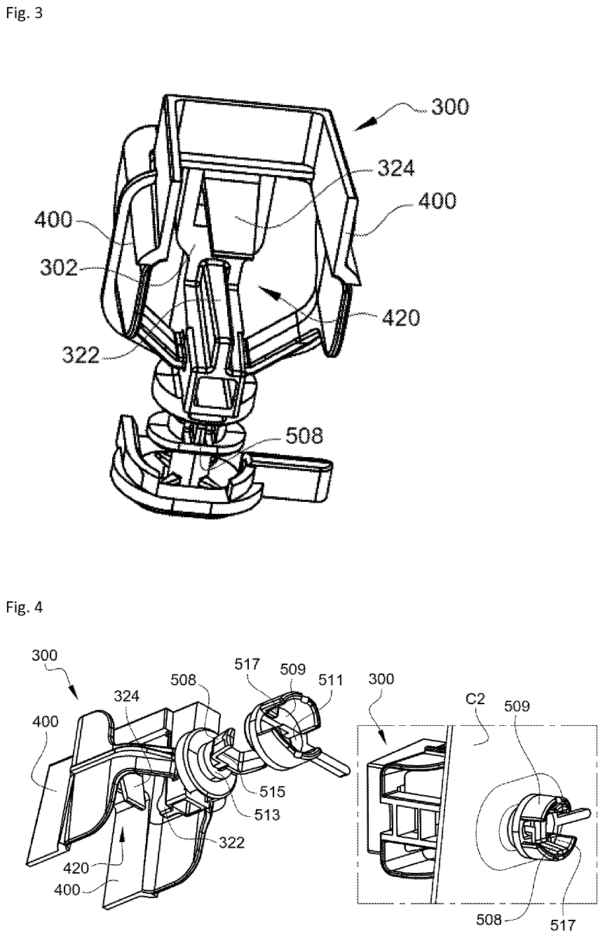

According to a variant represented in FIG. 3, the means for fixing the second element 300 comprise a locking member 508 having a locking portion. The locking member 508 may then be moved between an unlocked configuration in which the locking portion is able to be passed through a second slot 510 provided in the second support C2; and a locked configuration in which the locking portion is able to rest on the second support C2. The locking member 508 may in particular have a shape adapted to be inserted into the second slot 510 and to occupy the locked configuration when it is fixed to the second slot 510 by rotation of a quarter turn of the locking member 508.

Alternatively, and as represented in FIG. 4, the means for fixing the second element 300 comprise a locking member 508 having a locking portion intended to cooperate with a rest element 509. The locking member 508 may then be movable between an unlocked configuration in which the locking portion is able to be passed successively through a second slot 510 provided in the second support C2, and through a third slot 511 provided in the rest element 509; and a locked configuration in which the locking portion is able to rest on the rest element 509. Said rest element 509 being disposed between the locking portion of the locking member 508 and the second support C2 when the locking member 508 is in the locked configuration. The locking member 508 may in particular have a shape adapted to be inserted into the second slot 510 and the third slot 511. The locking member 508 may moreover occupy the locked configuration when it is fixed to the rest element 509 by rotation of a quarter turn of the locking member 508.

Advantageously, the locking member 508 may comprise a gripping part, for example formed by the second element 300, a first rest surface 513 and a second rest surface 515. The gripping part may in particular have a size allowing an operator to grasp it with a few fingers so as to be able to perform a rotation of a quarter turn. The first rest surface 513 is positioned between the gripping part and the second rest surface 515. Each of the longitudinal ends of the second rest surface 515 may be prolonged by the locking portion so that the locking portion may slide through cooperation by rotation with the rest element 509, to be placed in the locked configuration, in particular when the second rest surface 515 comes to rest on a shoulder 517 of the rest element 509.

According to a second example, the second slot 510 and the locking member 508 may have an oblong shape, the locked configuration is therefore obtained by rotation of a quarter turn of said oblong part of the locking member 508 which then comes to rest partially on the second support C2. Advantageously, the locking member 508 may comprise a sliding surface forming a ramp against which an edge of the second slot 510 is able to slide to allow the locking portion to pass through said second slot 510 between the unlocked configuration and the locked configuration.

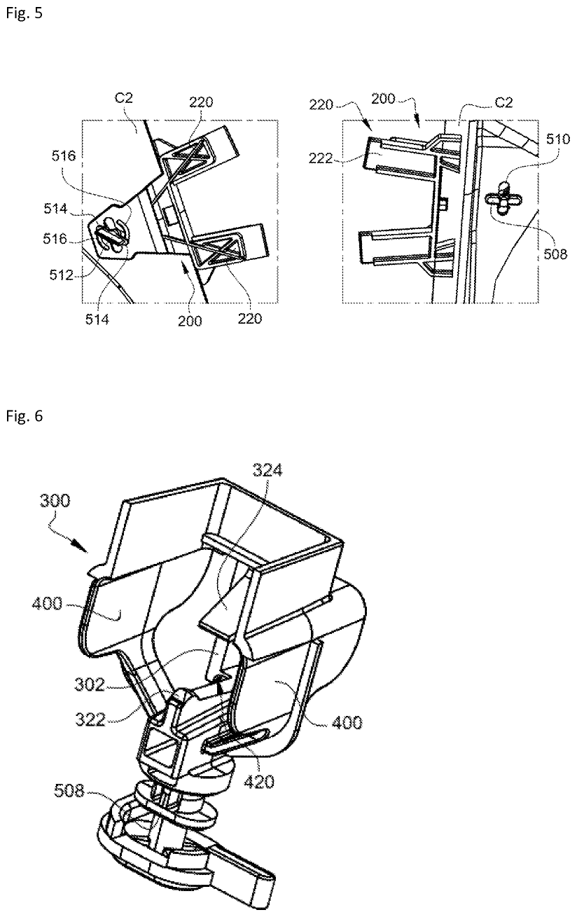

According to a third example represented in FIG. 5, the locking member 508 is included on the first element 200 and may comprise a blocking part 512 comprising two peaks 514 configured to slide respectively in two guides 516 provided in the first element 200 when the locking member 508 is moved between the unlocked configuration and the locked configuration by rotation.

The first element 200 may comprise at least one connecting member 220. As illustrated in FIGS. 1 to 6, the first element 200 may comprise two connecting members 220 spaced apart from each other and symmetrical with respect to a median plane. The connecting member 220 may comprise a first zone 222 having a substantially planar surface and a second zone 224 having a substantially planar surface and offset parallel to the first zone in the closing direction of the door leaf element. The second element 300 may comprise at least one retaining member 320 comprising an abutment surface 322 configured to cooperate with the first zone 222 so as to oppose a displacement of the door leaf element with respect to the fixed part in the closing direction of the door leaf element. For example, the first zone 222 may come to rest on the abutment surface 322, in particular when the door leaf element is moved in the direction of its closing. In particular, FIG. 6 illustrates an embodiment for which the abutment surface 322 comprises a portion of a sphere configured to present a substantially point-like zone of cooperation between the first zone 222 of the connecting member 220 and the abutment surface 322.

Advantageously, the material constituting the connecting member 220 has mechanical strength sufficient to prevent the complete closing of the door leaf element on the fixed part.

The second element also comprises at least one elastically deformable body 324, configured to cooperate with the second zone 224 of the at least one connecting member 220 so as to oppose the displacement of the door leaf element with respect to the fixed part in the opening direction of the door leaf element. In general, the displacement of the door leaf element with respect to the fixed part is a pivotal displacement.

The elastically deformable body 324 may comprise at least one tab configured to deform by pivoting and comprise a free distal end portion configured to cooperate with the connecting member 220.

According to one embodiment, the second zone 224 comes to rest on the free distal end portion of the elastically deformable body 324, in particular when the door leaf element is offset in the direction of its opening. Advantageously, the elastically deformable body 324 has stiffness sufficient to prevent an offset of the door leaf element with respect to the fixed part greater than a threshold value, for example substantially equal to 70 mm, when the elastically deformable body 324 is subjected to a force less than a target force, for example of between 10 N and 200 N. Furthermore, the elastically deformable body 324 may have elasticity sufficient to allow the opening of the door leaf element with respect to the fixed part beyond the threshold value, when the elastically deformable body 324 is subjected to a force greater than or equal to the target force. For this, the stiffness of the elastically deformable body 324 may be configured to make it possible to withstand a stress of between 30 MPa and 120 MPa and in particular between 60 MPa and 90 MPa.

It is in particular possible that the second element 300 has two retaining members 320 spaced apart from each other and symmetrical with respect to a median plane. The arrangements previously described, and in particular the presence of two connecting members 220 on the first element 200 and/or the presence of two retaining members 320 on the second element 300, make it possible to use a single first element 200 or a single second element 300 that may be adapted both to a left door leaf element and to a right door leaf element of a motor vehicle.

In the embodiment illustrated in FIG. 3, the second element 300 comprises a base body 302 from which the retaining member 320 extends. According to this embodiment, the elastically deformable body 324 may comprise a proximal end secured to the base body 302, said elastically deformable body 324 being configured to deform mainly at the proximal end. A groove may also extend from the base body 302, so as to form the abutment surface 322. The abutment surface 322 may then extend transversely with respect to the base body 302 in the plane of extension of the elastically deformable body 324 between the proximal end and the distal end. The elastically deformable body 324 and the abutment surface 322 may be offset in the extension plane so as to leave a space in which the connecting member 220 may be introduced.

The holding device 1 may further comprise at least one protective wall 400 defining a receiving housing 420 in which the at least one elastically deformable body 324 is at least partially housed. In other words, the receiving housing 420 may form a receiving cavity in which the at least one elastically deformable body 324 is at least partially housed. According to one embodiment, the at least one elastically deformable body 324 is completely contained within the receiving housing.

As illustrated in the figures, the holding device 1 may comprise a protective wall 400, or a plurality of protective walls 400. The protective wall(s) 400 may in particular define the receiving housing 420 so that it has a limited internal volume.

In this way, the protective wall 400 may be configured to at least partially protect the elastically deformable body 324, and in particular against splashes of paint.

According to a non-limiting variant, the retaining member 320 and the protective wall 400 both extend from the base body 302. Advantageously, the connecting member 220 may be configured to be housed at least partly within the receiving housing 420. In other words the connecting member 220 may extend at least partially in the receiving housing 420.

Advantageously, the protective wall 400 may be provided with a passage opening configured to allow the introduction of the connecting member 220 inside the receiving housing 420, or alternatively the removal of the connecting member 220 outside the receiving housing 420 so as to define an introduction axis. In this case the protective wall 400 may extend at least partly around the introduction axis. In this way, the protective wall 400 spatially encompasses the elastically deformable element 324 in all directions. According to one embodiment, the at least one protective wall 400 and the elastically deformable body 324 have a transverse dimension counted along the introduction axis. According to this embodiment, the transverse dimension of the at least one protective wall 400 is strictly greater than the transverse dimension of the elastically deformable body 324. In the same way, the at least one protective wall 400 and the elastically deformable body 324 may have a longitudinal dimension counted along a longitudinal direction perpendicular to the introduction axis. In this case, provision may be made for the longitudinal dimension of the at least one protective wall 400 to be strictly greater than the longitudinal dimension of the elastically deformable body 324. Finally, the at least one protective wall 400 and the elastically deformable body 324 may have a lateral dimension counted along a lateral direction perpendicular to the introduction axis and the longitudinal direction. In this case, the lateral dimension of the at least one protective wall 400 may be strictly greater than the lateral dimension of the elastically deformable body 324.

According to one embodiment, each of the transverse dimension, the longitudinal dimension and the lateral dimension of the at least one protective wall 400 is strictly greater than the corresponding dimension of the elastically deformable body 324. It may in particular be provided that the at least one protective wall 400 extends around the elastically deformable body 324 and has a lateral dimension, a longitudinal dimension and a transverse dimension strictly greater than the largest dimension of the elastically deformable body 324.

According to one embodiment, the protective wall 400 is offset with respect to the elastically deformable body 324 according to a plane perpendicular to the introduction axis. For example, the second element 300 illustrated in FIG. 3 comprises two protective walls 400 opposite with respect to the introduction axis. In particular, said two protective walls 400 may extend from the base body 302.

According to a non-limiting variant, the first element 200 and the second element 300 may each be made of a single material, for example a thermoplastic material. The first element 200 and the second element 300 may then be obtained by a thermoplastic molding method.

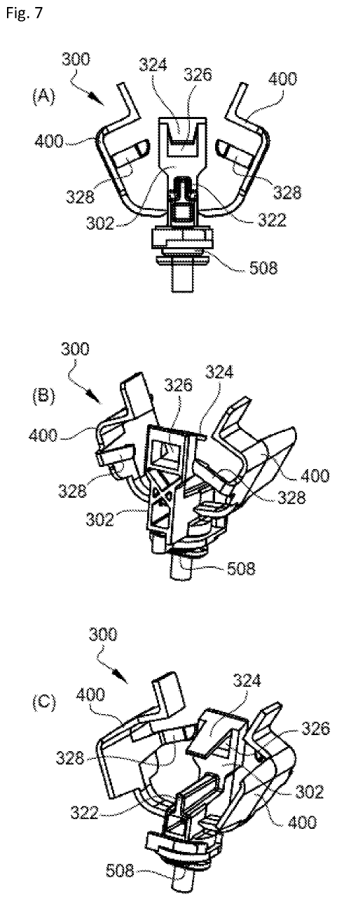

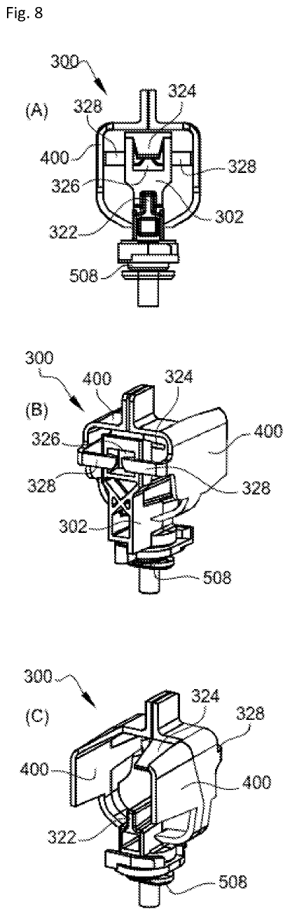

FIGS. 7 and 8 illustrate an embodiment in which the retaining member 320 comprises a female snap element 326 configured to cooperate with a male snap element 328 provided on the protective wall 400, so that the protective wall 400 may occupy a separate configuration, illustrated in FIG. 7, in which the female snap element 326 and the male snap element are disjointed and a snapped configuration, illustrated in FIG. 8, in which the female snap element 326 and the male snap element cooperate with each other.

According to a non-limiting variant, the second element 300 comprises two protective walls 400, each provided with a top part having a rest surface. Each protective wall 400 may comprise a main part offset transversely with respect to the introduction axis of the connecting member 220, the top part extending substantially perpendicular to the main part so as to partially form the receiving housing 420.

Alternatively or jointly, each protective wall 400 may comprise a male snap element 328. The base body 302 may then comprise a single female snap element 326, configured to cooperate in the snapped configuration with each male snap element 328 included on each protective wall 400. Thus, in the snapped configuration, the rest surfaces of each protective wall 400 may rest against each other to form the receiving housing 420.

Advantageously, the holding device 1 may be made by molding in the separate configuration and placed on the vehicle in the snapped configuration to guarantee a better protection of the retaining member 320 by the protective wall 400.

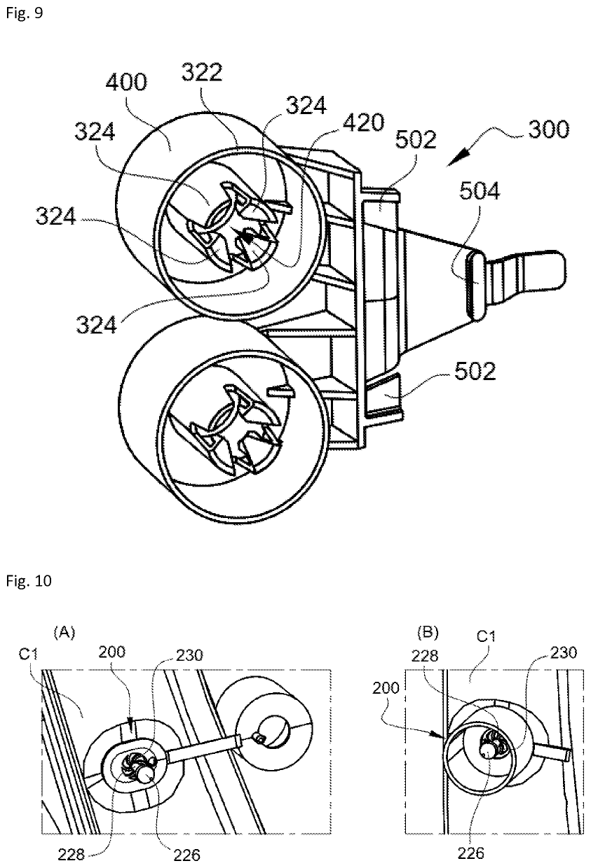

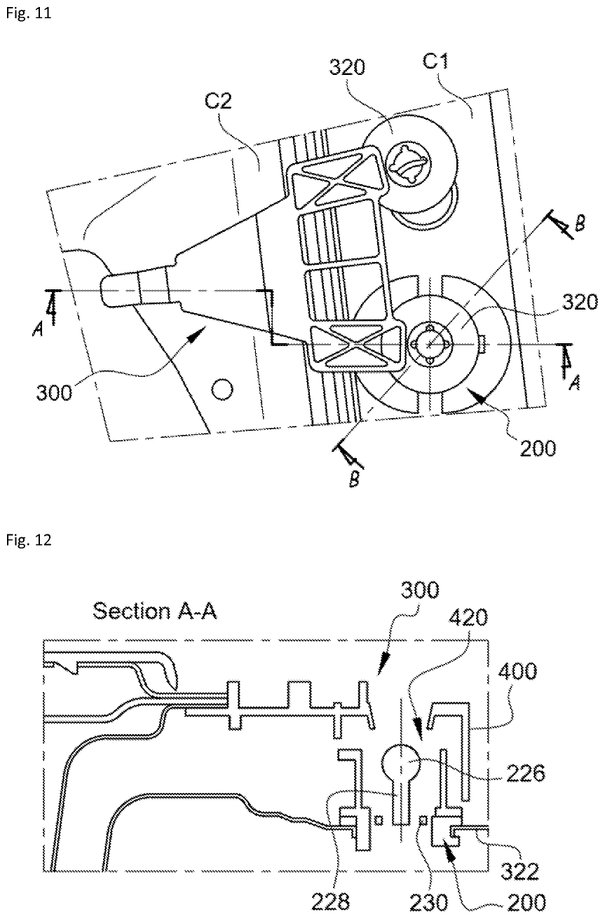

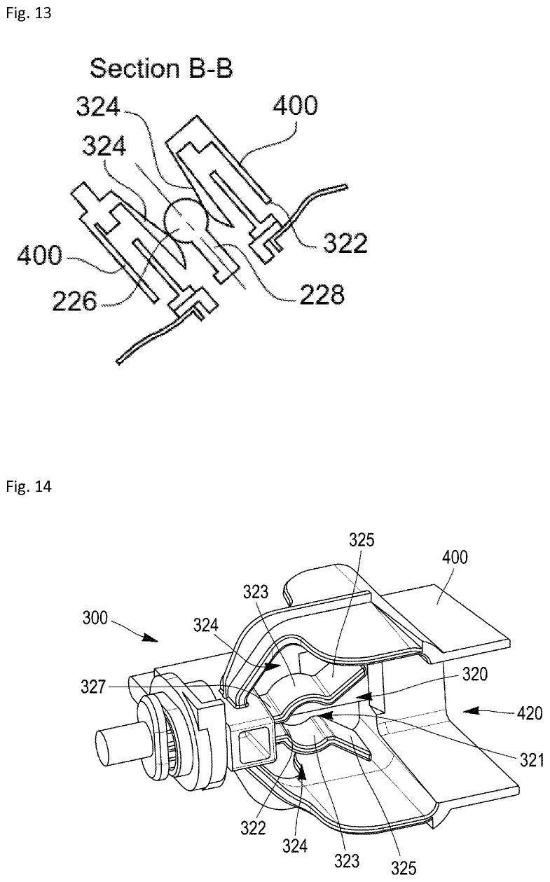

Referring to FIGS. 9 to 13, the retaining member 320 may comprise at least two elastically deformable bodies 324, and in particular four elastically deformable bodies 324. The connecting member 220 may then comprise a distal termination 226 configured to be inserted and snapped between said at least two elastically deformable bodies 324 and further comprises a connecting rod 228 connecting said distal termination 226 to the first element 200. The connecting rod 228 may comprise a first end secured to the distal termination 226 and a second end, opposed to the first end and secured to connecting arms 230 configured to allow a range of movement of the distal termination 226 with respect to the first support C1.

According to one embodiment, the first element 200 comprises the connecting arms 230 connecting the second end of the connecting rod 228 to the first element 200.

According to the non-limiting variant represented in FIG. 9, the protective wall 400 forms the abutment surface 322 and may have a substantially cylindrical shape. In particular, the protective wall may have a front edge defining the abutment surface 322.

The holding device 1 previously described makes it possible to hold a motor vehicle door in an ajar position during the manufacture of this vehicle. In particular, but not exclusively, the holding device 1 may be used during a step of treating the body shell with paint or an anti-corrosion coating. The presence of the protective wall 400 advantageously makes it possible to protect the elastically deformable body 324 against splashes of paint which could be ejected unintentionally by said elastically deformable body 324 during another step of the manufacturing method.

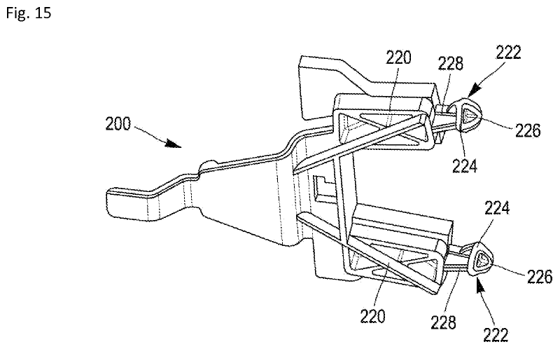

Referring to FIGS. 14 and 15, the retaining member 320 may comprise at least two elastically deformable bodies 324 forming a jaw intended to receive the connecting member 220. The retaining member may then comprise a base 327 connecting the jaw formed by the two elastically deformable bodies to the base body 302 of the retaining member 320. The jaw therefore comprises the two elastically deformable bodies 324 which are joined at the base 327, and thus define the abutment surface 322. The two elastically deformable bodies 324 are configured to elastically deform with respect to each other to allow the introduction of the connecting member 220 between them. The elastically deformable bodies 324 each comprise a convex curved section 323 configured to retain the connecting member 220 in a housing 321 formed between the two elastically deformable bodies 324. Advantageously, each elastically deformable body 324 comprises an end fin 325 connected to the convex curved section 323 and moving away from the introduction axis. Thus during the introduction of the connecting member 220, the slope formed by the end fins 325 allows easier introduction of the connecting member 220 into the housing 321 formed by the convex curved sections 323.

Referring now to FIG. 15, the connecting member 220 comprises a distal termination 226, for example in the general shape of a sphere, and configured to be inserted and snapped between said at least two elastically deformable bodies 324. As illustrated in FIG. 15, the first zone 222 of the connecting member 220 corresponds to a part of the distal termination 226 in the shape of a sphere and is configured to come to rest on the abutment surface 322 disposed between the convex curved sections 323 and the base 327. Furthermore, the second zone 224, disposed on a diametrically opposite part of the sphere-shaped distal termination, cooperates with the elastically deformable bodies 324 at the junction between the convex curved sections 323 and the end fins 325. The connecting member 220 further comprises a connecting rod 228 connecting said distal termination 226 to the first element 200.

According to one embodiment, the retaining member 320 is placed so that the elastically deformable bodies 324 are directed towards the interior of the vehicle. Thus, when the first support C1 approaches the second support C2, the connecting member 220 comes into contact against the end fins 325, which moving elastically away allowing the passage of the connecting member 220 before closing. The abutment surface 322 blocks the displacement in the closing direction of the door leaf, and the convex curved sections 323 prevent displacement in the opening direction of the door leaf.

Finally, the housing 321 formed by the convex curved sections 325 has a generally cylindrical shape, making it possible to form a sliding connection perpendicular to the introduction axis. Thus, the connecting member 220 may slide in the jaw, which makes it possible to adapt, along this axis, to strong variations in the position of the door leaf with respect to the fixed part.

1. A device for holding in the ajar position a door leaf element with respect to a fixed part of a body shell of a motor vehicle; comprising:
a first element intended to cooperate with a first support chosen from among the fixed part or the door leaf element, said first element comprising at least one connecting member;
a second element intended to cooperate with a second support chosen from among the fixed part or the door leaf element, said second element comprising at least one retaining member comprising at least one elastically deformable body, configured to cooperate with a second zone of the at least one connecting member so as to oppose the displacement of the door leaf element with respect to the fixed part in the opening direction of the door leaf element;
the holding device comprising at least one protective wall defining a receiving housing in which the at least one elastically deformable body is at least partially housed.

2. The holding device according to claim 1, comprising an abutment surface configured to cooperate with a first zone of the connecting member so as to oppose a displacement of the door leaf element with respect to the fixed part in the closing direction of the door leaf element.

3. The holding device according to claim 2, wherein the protective wall forms the abutment surface.

4. The holding device according to claim 1, wherein the elastically deformable body is configured to deform by pivoting, said elastically deformable body comprising a free distal end portion configured to cooperate with the connecting member.

5. The holding device according to claim 1, wherein the connecting member is configured to be housed at least partly in the receiving housing.

6. The holding device according to claim 1, wherein the protective wall comprises a passage opening configured to allow the introduction of the connecting member inside the receiving housing, or alternatively the removal of the connecting member outside the receiving housing so as to define an introduction axis.

7. The holding device according to claim 6, wherein the protective wall extends at least partly around the introduction axis.

8. The holding device according to claim 1, wherein the retaining member comprises at least two elastically deformable bodies and wherein the connecting member comprises a distal termination configured to be inserted between said at least two elastically deformable bodies, and further comprises a connecting rod connecting said distal termination to the first element.

9. The holding device according to claim 8, wherein the connecting rod comprises a first end secured to the distal termination and a second end, opposed to the first end and secured to connecting arms configured to allow range of movement of the distal termination with respect to the first support.

10. The holding device according to claim 1, wherein the retaining member comprises a female snap element configured to cooperate with a male snap element provided on the protective wall, so that the protective wall may occupy a separate configuration in which the female snap element and the male snap element are disjointed and a snapped configuration in which the female snap element and the male snap element cooperate with each other.

11. The holding device according to claim 10, wherein the first element and the second element comprise fixing means, intended to allow the fixing of the first element with the first support and of the second element with the second support.

12. The holding device according to claim 11, wherein the fixing means comprise a snap member intended to snap into a first slot included on the first support and/or the second support.

13. The holding device according to claim 11, wherein the fixing means comprise a locking member having a locking portion, the locking member being movable between an unlocked configuration in which the locking portion is able to passed through a second slot provided in the first support or the second support; and a locked configuration in which the locking portion is able to rest on the first support or the second support.

14. The holding device according to claim 13, wherein the locking member comprises a sliding surface forming a ramp against which an edge of the second slot is able to slide to allow the passage of the locking portion through said second slot between the unlocked configuration and the locked configuration.

15. A vehicle provided with at least one holding device according to claim 1.
